(19) United States
(12) Patent Application Publication
(10) Pub. No.: US 2022/0082768 A1
(43) Pub. Date: Mar. 17, 2022

(54) OPTICAL MODULE AND OPTICAL CONNECTOR CABLE

(71) Applicant: SUMITOMO ELECTRIC INDUSTRIES, LTD., Osaka (JP)

(72) Inventors: Takuya ISHIDA, Osaka-shi (JP); Takeshi INOUE, Osaka-shi (JP); Tatsuhiko NAITO, Osaka-shi (JP)

(73) Assignee: SUMITOMO ELECTRIC INDUSTRIES, LTD., Osaka (JP)

(21) Appl. No.: 17/470,028

(22) Filed: Sep. 9, 2021

(30) Foreign Application Priority Data
Sep. 17, 2020 (JP) 2020-156678

(51) Int. Cl. G02B 6/42

(52) U.S. Cl. CPC G02B 6/4214

(57) ABSTRACT

An optical module includes a substrate, an optical element, and a lens module. The substrate has a first surface and a second surface facing each other. The optical element is mounted on the substrate. The lens module has a lens configured to be optically coupled to the optical element and optically couples an optical fiber and the optical element to each other via the lens. The substrate is provided with a cavity recessed from the first surface toward the second surface to have a bottom portion, and at least a part of the lens module is housed inside the cavity.

### CROSS-REFERENCE TO RELATED APPLICATION

This application is based upon and claims the benefit of priority from Japanese Patent Application No. 2020-156678, filed on Sep. 17, 2020, the entire contents of which are incorporated herein by reference.

### TECHNICAL FIELD

The present disclosure relates to an optical module and an optical connector cable.

### BACKGROUND

JP2019-082508A discloses an example of an optical component that optically connects an optical fiber to a photoelectric conversion element mounted on a substrate. The optical component converts light emitted from the optical fiber in a horizontal direction into light propagating in a vertical direction by a lens component and makes the propagating light be incident on the photoelectric conversion element mounted on the substrate.

### SUMMARY

An optical module of the present disclosure includes a substrate, an optical element, and a lens module. The substrate has a first surface and a second surface facing each other. The optical element is mounted on the substrate. The lens module has a lens configured to be optically coupled to the optical element, and optically couples an optical fiber and the optical element to each other via the lens. The substrate is provided with a cavity recessed from the first surface toward the second surface to have a bottom portion, and at least a part of the lens module is housed inside the cavity.

An optical connector cable of the present disclosure includes the above-mentioned optical module and an optical fiber cable. The optical fiber cable has at least one optical fiber. In the optical connector cable, the optical fiber cable is attached to the optical module such that the optical fiber is optically coupled to the optical element via the lens.

### BRIEF DESCRIPTION OF THE DRAWINGS

The foregoing and other purposes, aspects and advantages will be better understood from the following detailed description of embodiments of the disclosure with reference to the drawings, in which:

FIG. 1 is a perspective view showing an optical connector cable according to an embodiment;

FIG. 2 is a perspective view showing the optical connector cable from which a protective member is removed;

FIG. 3 is a plan view of an optical module from a first surface of a substrate;

FIG. 4 is a plan view of the optical module from a second surface of the substrate;

FIG. 5 is a cross-sectional view of the optical module along line V-V shown in FIG. 3;

FIG. 6 is an enlarged view of a portion surrounded by a broken line A shown in FIG. 5;

FIG. 7 is a perspective view showing the substrate used for the optical module shown in FIG. 3; and

FIG. 8 is an enlarged view of a portion surrounded by a broken line B shown in FIG. 7.

### DETAILED DESCRIPTION

### Problems to be Solved by the Present Disclosure

As described in JP2019-082508A, the optical module that optically connects the optical fiber with the optical element has a layered structure in which a lens module is stacked on the substrate. Accordingly, the thickness of the entire optical module is increased by the thickness of the lens module and the substrate. When the thickness of the optical module is large, miniaturization of a device on which the optical module is mounted may be hindered. Thus, it is desired to develop an optical module of which becomes thinner.

### Effects of the Present Disclosure

According to the present disclosure, the optical module can become thinner.

### DESCRIPTION OF EMBODIMENTS OF THE PRESENT DISCLOSURE

First, the contents of the embodiments of the present disclosure will be listed and described. An optical module according to an embodiment includes a substrate, an optical element, and a lens module. The substrate has a first surface and a second surface facing each other. The optical element is mounted on the substrate. The lens module has a lens configured to be optically coupled to the optical element and optically couples an optical fiber and the optical element to each other via the lens. The substrate is provided with a cavity recessed from the first surface toward the second surface to have a bottom portion, and at least a part of the lens module is housed inside the cavity.

In this optical module, the cavity recessed in a thickness direction (a direction from the first surface toward the second surface) is provided with the substrate, and at least a part of the lens module is housed inside the cavity. Accordingly, the thickness of the optical module is reduced by the amount of the lens module which is housed in the cavity, and thus the optical module becomes thinner. In the optical module of the related art in which the cavity is not provided in the substrate, the lens module is placed on a flat surface of the substrate. In this case, a gap between the height of the optical fiber which extends outside the substrate and the height of the end portion of the optical fiber which is installed on the substrate is large, and thus it is necessary to bend the optical fiber significantly (it is necessary to increase the curvature). On the other hand, the optical module according to the present embodiment houses the lens module in the cavity of the substrate, and thus the height of the optical fiber which is installed on the substrate becomes low, and the above gap becomes small. Therefore, the bending of the optical fiber can be reduced, and damage to the optical fiber due to bending stress can be suppressed.

As an embodiment, the lens module may have a holding part configured to hold an end portion of the optical fiber. According to this aspect, the end portion of the optical fiber is held by the holding part of the lens module having the lens, and thus it is possible to make the optical coupling between the optical element and the optical fiber more accurate. Since it is not necessary to prepare a component having the holding part as a component separate from the lens module in this embodiment, component management at the time of manufacturing the optical module becomes easy.

As an embodiment, the cavity may be provided with a through hole that corresponds to the lens of the lens module and extends from the bottom portion of the cavity to the second surface. The optical element may be mounted on the second surface of the substrate such that at least a part of the optical element overlaps the through hole in the thickness direction of the substrate. According to this aspect, the lens of the lens module and the optical element mounted on the second surface of the substrate can be optically coupled to each other via a simple configuration of the through hole.

As an embodiment, the through hole may have a tapered shape in which an inner diameter thereof decreases from the bottom portion of the cavity toward the second surface. According to this aspect, the size of the through hole can be made smaller than that of the straight through hole having a constant inner diameter. Accordingly, the strength of the substrate can be maintained even in a case in which the through hole is provided. By making the shape of the through hole a tapered shape in which an inner diameter thereof decreases from the bottom portion of the cavity toward the second surface, it is possible to prevent the path of the light that converges from the lens toward the optical element from being obstructed. Further, by reducing the inner diameter of the through hole on the second surface, it is possible to expand a region in which a wiring pattern can be disposed on the second surface.

As an embodiment, the cavity may have a first cavity close to the first surface and a second cavity having a second bottom portion closer to the second surface than a first bottom portion of the first cavity. The through hole may be provided in the second bottom portion of the second cavity. According to this aspect, only a portion of the cavity that mainly houses the lens, which tends to protrude from a bottom surface of the lens module, is deepened, and other portions are made shallower than that portion. Therefore, it is possible to make a region of the entire cavity smaller. As a result, it is possible to maintain the strength of the substrate even in a configuration in which the substrate is provided with the cavity.

As an embodiment, a depth of the cavity from the first surface to the bottom portion may be equal to or more than half a thickness of the lens module or half a thickness of the substrate. As the depth of the cavity becomes deeper, a larger portion of the lens module can be housed inside the cavity. According to the above aspect, the optical module can become even thinner. When the cavity is constituted by the first cavity and the second cavity, the depth of the cavity is the depth of the first cavity from the first surface to the first bottom portion.

As an embodiment, the cavity may include a plurality of cavities, and a beam part extending from an inside of the substrate to an outside thereof may be provided between the cavities. According to this aspect, a part of an outer edge of each cavity is defined by the beam part. The strength of the substrate is improved by the beam part being provided.

As an embodiment, the cavity may have two or more holes or marks used to position the lens module with respect to the cavity. According to this aspect, the lens module can be easily housed at an appropriate position in the cavity, and the efficiency of optical coupling between the lens and the optical element can be improved.

As an embodiment, a focal point of the lens may be located at an inside of the optical element. According to this aspect, the optical coupling efficiency between the lens and the optical element can be maintained even in a case in which a slight deviation occurs in a relative position between the lens and the optical element.

As an embodiment, an attachment portion of the optical fiber located on the substrate may extend along the first surface, and a central axis of the attachment portion may be located inside the cavity. According to this aspect, it is possible to make the gap between the height of a portion of the optical fiber which extends outside the substrate and the height of the attachment portion of the optical fiber smaller. Therefore, the bending of the optical fiber can be further reduced, and thus damage to the optical fiber due to bending stress is further suppressed.

As an embodiment, the lens module may have a mirror which converts a propagation direction of light such that light emitted from the optical fiber is incident on the optical element or light emitted from the optical element is incident on the optical fiber. According to this aspect, the optical fiber located along the substrate and the optical element located with respect to the optical fiber with the substrate interposed therebetween can be optically coupled to each other using the mirror.

An optical connector cable according to an embodiment includes the optical module according to any one the above-mentioned aspects and an optical fiber cable. The optical fiber cable has at least one optical fiber. In this optical connector cable, the optical fiber cable is attached to the optical module such that the optical fiber is optically coupled to the optical element via the lens.

In the optical connector cable, at least a part of the lens module is housed in the cavity provided in the substrate of the optical module. Accordingly, the thickness of the optical module is reduced by the amount of the lens module which is housed in the cavity and the optical module becomes thinner. Thus, the optical connector cable including the optical module also becomes thinner. In this optical connector cable, the gap between the height of the optical fiber which extends outside the substrate and the height of the end portion of the optical fiber which is installed on the substrate is small. Thus, the bending of the optical fiber and the optical fiber cable can be reduced, and damage due to bending stress can be suppressed.

### DETAILS OF EMBODIMENTS OF THE PRESENT DISCLOSURE

Specific examples of the optical module and the optical connector cable according to the present disclosure will be described below with reference to the drawings. The present disclosure is not limited to these examples, but is defined by the scope of the claims, and is intended to include meanings equivalent to the scope of the claims and all modifications within the scope. In the description of the drawings, the same elements will be denoted by the same reference signs, and duplicate description will be omitted.

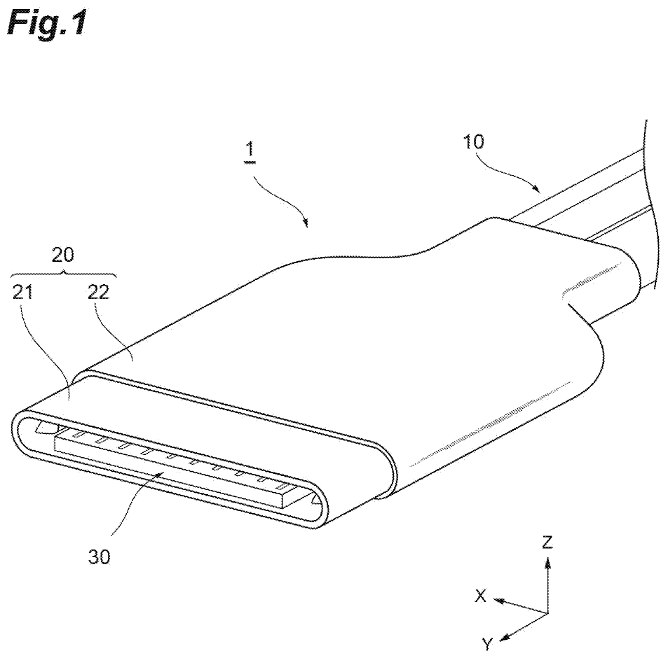

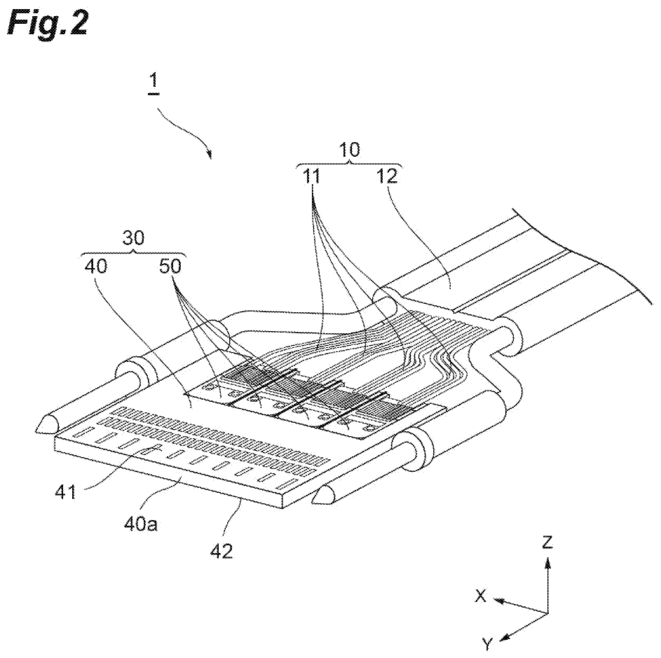

An optical connector cable 1 according to an embodiment will be described with reference to FIGS. 1 and 2. FIG. 1 is a perspective view showing an optical connector cable 1 according to the embodiment. FIG. 2 is a perspective view showing the optical connector cable 1 from which a protective member 20 is removed. Hereinafter, for the sake of explanation, a width direction of an end portion of the optical connector cable 1 is defined as a direction X, an extending direction of the end portion is defined as a direction Y, and a thickness direction of the end portion is defined as a direction Z. In the present embodiment, the direction X, the direction Y, and the direction Z are orthogonal to each other.

The optical connector cable 1 is, for example, a cable used when an optical signal is transmitted and received between devices. As shown in FIGS. 1 and 2, the optical connector cable 1 includes an optical fiber cable 10, a protective member 20, and an optical module 30. Although one end of the optical fiber cable 10 is shown in FIGS. 1 and 2, the other end of the optical fiber cable 10 may have the same configuration.

As shown in FIG. 2, the optical fiber cable 10 has a plurality of optical fibers 11 and a cable sheath 12. Each optical fiber 11 is a member for transmitting an optical signal. Most of each optical fiber 11 is housed inside the cable sheath 12, and a tip end portion thereof is exposed to the outside of the cable sheath 12. The plurality of optical fibers 11 are arranged one-dimensionally in the direction X. Inside the cable sheath 12, all optical fibers 11 are housed in close contact with each other. On the other hand, outside the cable sheath 12, the plurality of optical fibers 11 are branched into several (four to six in the present embodiment) bundles, and an end portion of each bundle is held by a lens module 50. Each optical fiber 11 has, for example, a glass fiber, which includes a core and a cladding surrounding the core, and a resin coating the glass fiber. Each optical fiber 11 may be a single mode optical fiber (SMF) or a multimode optical fiber (MMF).

As shown in FIG. 1, the protective member 20 has a flat shape extending in the direction X and the direction Y. The optical module 30 is housed inside the protective member 20. The protective member 20 protects the optical module 30 from an external impact or the like. The protective member 20 has an inner layer 21 and an outer layer 22 that covers the inner layer 21. A material of the inner layer 21 may be, for example, a metal. A material of the outer layer 22 may be, for example, a resin. At a tip end of the optical connector cable 1, a part of the inner layer 21 is exposed from the outer layer 22. This exposed portion is inserted into, for example, a socket provided in the device to which the optical connector cable 1 is connected.

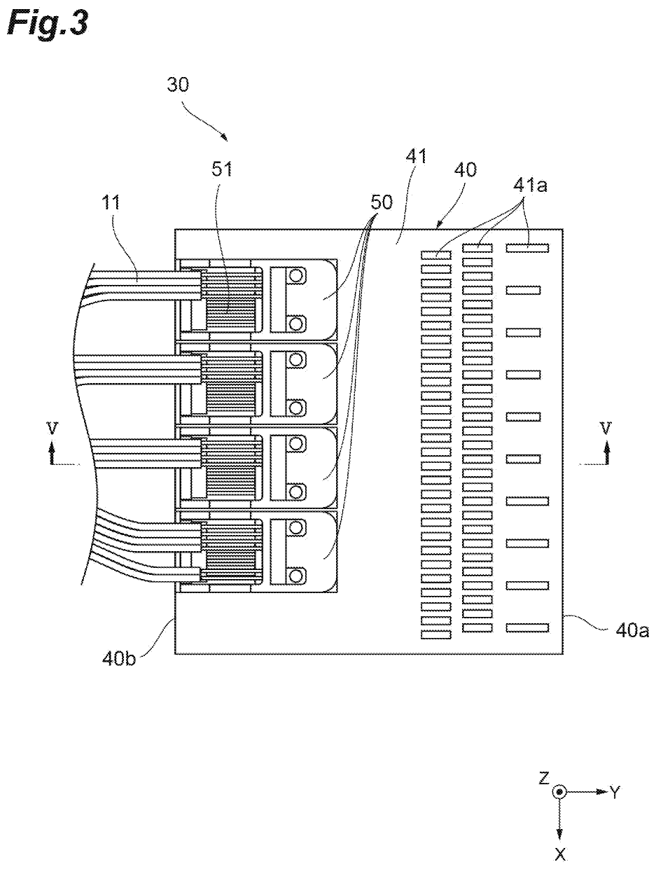

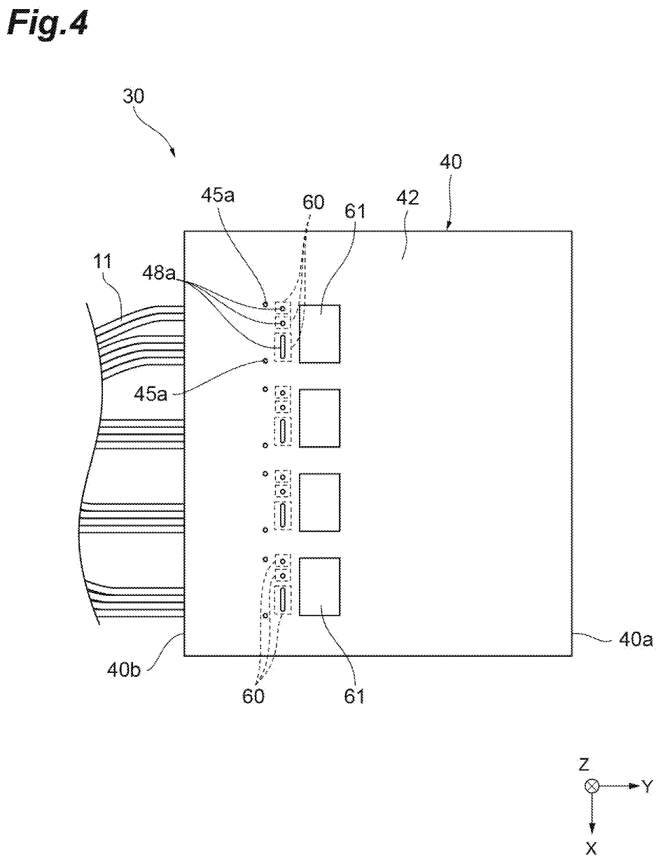

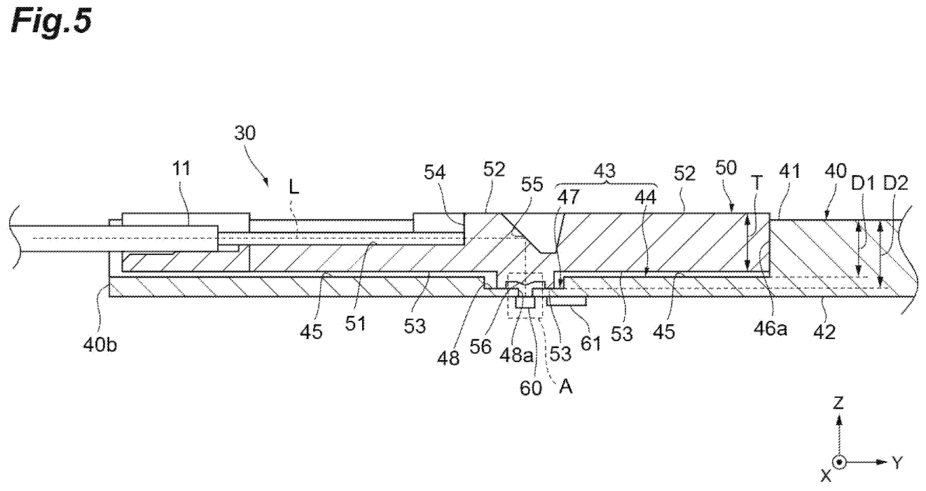

Next, the optical module 30 will be described with reference to FIGS. 3 to 6. FIG. 3 is a plan view of the optical module 30 from a first surface 41 of a substrate 40. FIG. 4 is a plan view of the optical module 30 from a second surface 42 of the substrate 40. FIG. 5 is a cross-sectional view of the optical module 30 along line V-V shown in FIG. 3.

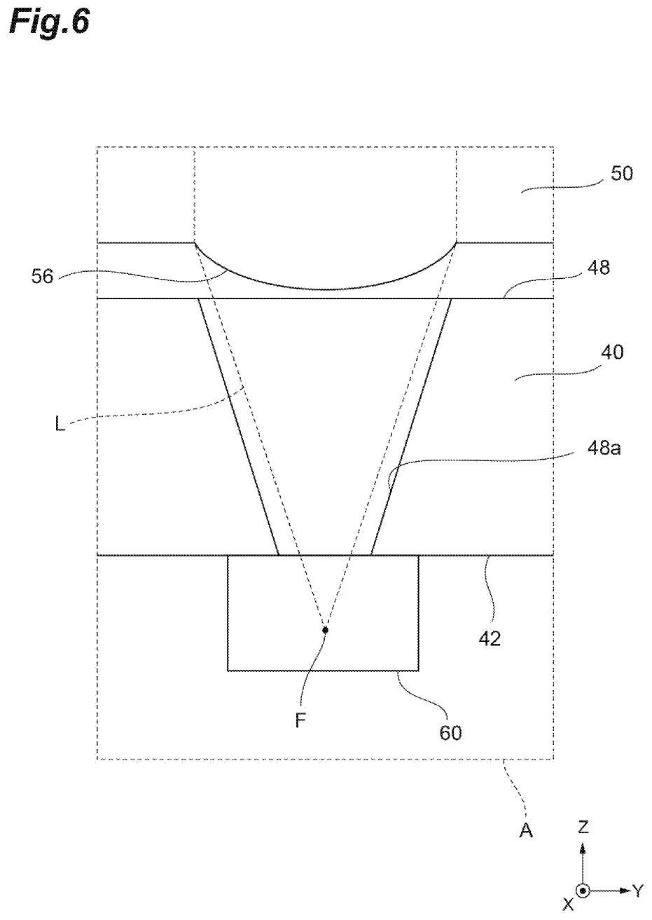

FIG. 6 is an enlarged view of a portion surrounded by a broken line A shown in FIG. 5. The optical module 30 includes a substrate 40, a plurality of lens modules 50, a plurality of optical elements 60, and a plurality of ICs 61.

The substrate 40 is a plate-shaped member on which various optical elements and electronic elements are mounted. The substrate 40 has a first end surface 40a and a second end surface 40b that face each other in the direction Y. The thickness of the substrate 40 may be 0.2 mm or more and 0.8 mm or less. Inside the substrate 40, various wirings (not shown) for electrically connecting ICs 61, electronic elements 60, and the like are provided. Hereinafter, in the direction Y, a side on which the first end surface 40a is located is defined as a tip end side of the optical module 30, and a side on which the second end surface 40b is located is defined as a base end side of the optical module 30. The substrate 40 has a first surface 41 and a second surface 42 facing each other in the direction Z. Hereinafter, in the direction Z, a side on which the first surface 41 is located is defined as an upper side of the optical module 30, and a side on which the second surface 42 is located is defined as a lower side of the optical module 30.

As shown in FIG. 3, the first surface 41 of the substrate 40 extends in the direction X and the direction Y and is formed in a rectangular shape in a plan view. A plurality of patterns 41a, which are metal films, are provided in a region of the first surface 41 near the first end surface 40a. On the other hand, in a region of the first surface 41 near the second end surface 40b, a plurality of lens modules 50 are placed side by side in the direction X.

As shown in FIG. 4, the second surface 42 of the substrate 40 extends in the direction X and the direction Y and is formed in a rectangular shape in a plan view. The plurality of optical elements 60 and the plurality of ICs 61 are mounted in a region of the second surface 42 near the second end surface 40b. In the present embodiment, for convenience of explanation, each optical element 60 is shown by a broken line. Each optical element 60 is a light receiving element such as a photodiode (PD). A light receiving surface of each optical element 60 faces the lens module 50. Each optical element 60 overlaps a through hole 48a provided in the substrate 40 in the thickness direction (the direction Z) of the substrate 40. As a result, the optical element 60 can receive light from the lens module 50 facing the optical element 60 with the substrate 40 interposed therebetween via the through hole 48a. The optical element 60 may be a light emitting element such as a vertical cavity surface emitting laser (VCSEL). Since the optical element 60 is disposed on the second surface 42, the through hole 48a is formed such that the opening area of the through hole 48a on the second surface 42 is smaller than the surface area of the optical element 60. Each IC 61 is an integrated circuit that controls an operation of the optical element 60. Each IC 61 may be connected to the optical element 60 via, for example, wiring in the substrate 40, a bonding wire, or the like. In the present embodiment, one IC 61 is connected to three optical elements 60. By disposing the IC 61 near the optical element 60 (for example, disposing the IC 61 adjacent to the optical element 60), it is possible to maintain a communication speed between the IC 61 and the optical element 60 high.

The lens module 50 is a component that optically couples the optical fiber 11 with the optical element 60. The lens module 50 is formed of a material (for example, glass or a light transmitting resin) that transmits light emitted from the optical fiber 11. As shown in FIG. 5, the lens module 50 reflects the light L emitted from the optical fiber 11 in the direction Y by a mirror 55 included therein, and converts a propagation direction of the light L into a direction in the direction Z. For example, the mirror 55 reflects the incident light L in a direction 90 degrees from a direction of incidence. The light L reflected by the mirror 55 is incident on the optical element 60 through the through hole 48a provided in the substrate 40. The lens module 50 has a groove portion 51, an upper surface 52, a lower surface 53, an abutting surface 54, the mirror 55, and a lens 56.

The groove portion 51 includes a V groove (a groove forming a V shape in a XZ plane) extending in the direction Y and is a holding part which holds the end portion of the optical fiber 11. The groove portion 51 defines the position of the optical fiber 11 with respect to the lens module 50 and prevents the position of the optical fiber 11 from being deviated in the direction X. The end portion of the optical fiber 11 placed in the groove portion 51 is fixed to the groove portion 51 with, for example, an adhesive. The adhesive may be, for example, an ultraviolet curable adhesive or a light-transmitting adhesive that transmits the light L emitted from the optical fiber 11. The shape of the groove portion 51 is not limited to the V groove and may be, for example, a U groove having a rounded bottom portion, or a rectangular groove having a bottom surface extending in the direction X and the direction Y. The holding part (the groove portion 51 in the present embodiment) that holds the end portion of the optical fiber 11 may not be provided in the lens module 50. For example, the groove portion 51 may be provided in a separate component different from the lens module 50. When the groove portion 51 is provided in the separate component, for example, the lens module 50 may have a pair of projections, the separate component provided with the groove portion 51 may have a pair of recesses, and each projection of the lens module 50 may be fitted to each recess of the separate component. Therefore, the lens module 50 and another component may be connected to each other.

The upper surface 52 is a surface located on an upper portion of the lens module 50 and extends in the direction X and the direction Y. The upper surface 52 is located on a tip end (a right area in FIG. 5) of the lens module 50 with respect to the groove portion 51. The upper surface 52 is provided with a depression having the mirror 55. The lower surface 53 is a surface located on a lower portion of the lens module 50 and extends in the direction X and the direction Y. Most of the lower surface 53 faces the groove portion 51 and the upper surface 52 in the direction Z.

The abutting surface 54 is a surface on which a tip end surface of the optical fiber 11 abuts and extends along the direction X and the direction Z. The abutting surface 54 connects an end portion of the groove portion 51 and an end portion of the upper surface 52 to each other. The light L emitted from the optical fiber 11 passes through the abutting surface 54 and is incident on the mirror 55. The abutting surface 54 and the tip end surface of the optical fiber 11 may not be in direct contact with each other and may be fixed to each other via a light-transmitting adhesive or a refractive index matching agent that transmits the light L.

The mirror 55 converts the propagation direction of the light L emitted from the optical fiber 11. The mirror 55 is provided to be inclined with respect to each of a XY plane and the XZ plane. The mirror 55 receives the light L emitted from the optical fiber 11 in the direction Y and reflects the light L toward the lens 56. An incident optical axis and a reflecting optical axis of the light L may form a right angle, for example.

The lens 56 is optically coupled to the optical element 60. The lens 56 is provided in a portion of the lens module 50 that protrudes downward. As shown in FIG. 6, the lens 56 faces the optical element 60 in the direction Z. The lens 56 has a curved surface toward the optical element 60 to be a convex shape. A focal point F of the lens 56 is located at an inside of the optical element 60 rather than a surface of the optical element 60. The lens 56 converges the light L reflected by the mirror 55 and causes the light L to be incident on the optical element 60. Various parameters of the lens 56 (for example, the surface shape, the size, the material, or the like of the lens 56) are optimized such that the focal point F of the lens 56 is located inside the optical element 60.

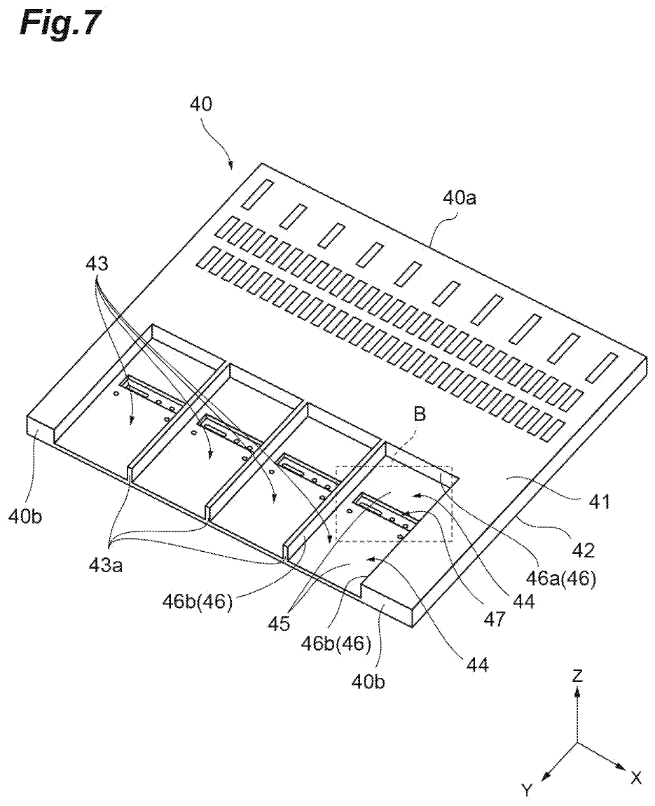

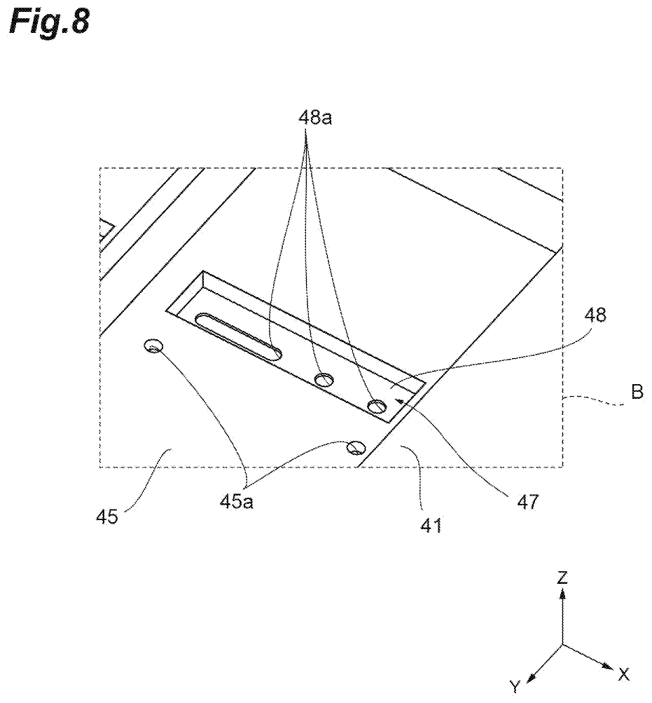

Next, the detailed configuration of the substrate 40 will be described with reference to FIGS. 7 and 8. FIG. 7 is a perspective view showing the substrate 40. FIG. 8 is an enlarged view of a portion surrounded by a broken line B shown in FIG. 7. As shown in FIG. 7, the substrate 40 is provided with a plurality of cavities 43. Each cavity 43 is a depression recessed from the first surface 41 toward the second surface 42. The lens module 50 is housed inside each cavity 43. The plurality of cavities 43 are arranged in the direction X. The number of the cavities 43 may be equal to or greater than the number of the lens modules 50 mounted on the substrate 40. In the present embodiment, the same number (four) of the cavities 43 as the number of lens modules 50 are provided. Each cavity 43 may be formed by, for example, spot facing processing. A beam part 43a extending from an inside of the substrate 40 to an outside thereof in the direction Y is provided between the adjacent cavities 43. The beam part 43a is formed to rise from a first bottom portion 45 of each cavity 43 toward the first surface 41 of the substrate 40.

Each cavity 43 includes a first cavity 44 and a second cavity 47. The first cavity 44 is a depression that forms most of the cavity 43 and has the first bottom portion 45 and a wall surface 46. The first bottom portion 45 is a portion on which the lens module 50 is placed and, in the present embodiment, is a flat surface extending in the direction X and the direction Y. An outer edge of the first bottom portion 45 in the direction Z has a rectangular shape having a long side extending in the direction Y. The first bottom portion 45 has a size on which the entire lens module 50 can be placed. A case in which the lens module 50 is placed on the first bottom portion 45 includes not only a case in which the lens module 50 is placed on the first bottom portion 45 to be in direct contact with the first bottom portion 45, but also a case in which the lens module 50 is placed on the first bottom portion 45 via a member such as an adhesive.

As shown in FIG. 8, the first bottom portion 45 has a pair of positioning holes 45a. Each positioning hole 45a is a hole that penetrates the substrate from the first bottom portion 45 to the second surface 42 (see FIG. 4). The pair of positioning holes 45a function as a positioning mechanism for the lens module 50 with respect to the cavity 43. For example, the lens module 50 is provided with the pair of projections corresponding to the pair of positioning holes 45a, and the lens module 50 is placed such that each of the pair of projections is fitted into each of the pair of positioning holes 45a. As a result, the lens 56 (see FIG. 5) and the optical element 60 are optically coupled to each other suitably. The number of the positioning holes 45a may be one, but by forming two or more positioning holes 45a, it is possible to perform the positioning of the lens module 50 more accurately. Each positioning hole 45a may not be a through hole that penetrates the substrate from the first bottom portion 45 to the second surface 42 and may be a non-through hole having a bottom surface.

A configuration of the positioning mechanism used for positioning the lens module 50 is not limited to the positioning hole 45a and may be a mark. For example, the lens 56 and the optical element 60 may be optically coupled to each other suitably by a mark being provided on each of the first bottom portion 45 and the lens module 50 and the lens module 50 being placed at a position where the marks overlap each other. To make the mark provided on the first bottom portion 45 visible via the lens module 50, the material of the lens module 50 may be a material that transmits visible light (for example, glass or a light transmitting resin).

As shown in FIG. 7, the wall surface 46 is a surface that rises from the outer edge of the first bottom portion 45 toward the first surface 41 of the substrate 40. The wall surface 46 has a first wall surface 46a and a pair of second wall surfaces 46b. The first wall surface 46a is provided at an end portion of the first cavity 44 near the first end surface 40a and extends in the direction X and the direction Z. The first wall surface 46a faces a tip end surface of the lens module 50 which is housed in the cavity 43. The first wall surface 46a may not contact with the lens module 50 which is housed in the cavity 43, and a gap may be provided between the first wall surface 46a and the lens module 50. A corner portion where the first wall surface 46a and the first bottom portion 45 intersect may have an R shape.

The pair of second wall surfaces 46b face each other in the direction X and extend in the direction Y and the direction Z. Each second wall surface 46b faces each side surface of the lens module 50 which is housed in the cavity 43. The second wall surface 46b may not contact with the lens module 50 which is housed in the cavity 43, and a gap may be provided between the second wall surface 46b and the lens module 50. A corner portion where the second wall surface 46b and the first bottom portion 45 intersect may have an R shape. A wall surface is not provided at the end portion of the first cavity 44 near the second end surface 40b. That is, the cavity 43 is open in the second end surface 40b. As a result, the lens module 50 can be housed inside the cavity 43 from the opening. Further, in a state in which the lens module 50 is housed in the cavity 43, the optical fiber 11 connected to the lens module 50 can be pulled out from the opening to the outside of the cavity 43.

As shown in FIG. 8, the second cavity 47 is a depression provided in the first bottom portion 45 of the first cavity 44. The second cavity 47 is formed to extend in the direction X. The second cavity 47 has a second bottom portion 48 located closer to the second surface 42 than the first bottom portion 45 of the first cavity 44. In the present embodiment, the second bottom portion 48 is a flat surface extending in the direction X and the direction Y. Apart of the lens module 50 (a portion protruding downward in the direction Z) is placed on the second bottom portion 48 (see FIG. 5). The second bottom portion 48 is provided with a plurality of through holes 48a. Two round holes and one elongated hole are provided as the through holes 48a for each second cavity 47. The number and the shape of the through holes 48a are not limited to this and may be appropriately changed depending on the number or the shape of the optical elements 60 (see FIG. 4) which are mounted on the second surface 42. As shown in FIG. 6, the through hole 48a penetrates the substrate from the second bottom portion 48 to the second surface 42. The light L from the lens 56 toward the optical element 60 passes through the inside of the through hole 48a. The through hole 48a has a tapered shape in which the inner diameter decreases from the second bottom portion 48 toward the second surface 42. The inner diameter and the taper angle of the through hole 48a are optimized to a magnitude that does not obstruct a path of the light L from the lens 56 to the optical element 60. The through hole 48a may be a straight through hole having a constant inner diameter.

An aspect in which the lens module 50 is housed in the cavity 43 will be described with reference to FIG. 5. As shown in FIG. 5, most of the lens module 50 is housed in the first cavity 44, and a portion where the lens 56 is provided (the portion protruding downward along the direction Z) is housed in the second cavity 47. In the present embodiment, the entire configuration of the lens module 50 is located on the substrate 40, but a base end portion (an end portion on a left side in FIG. 5) of the lens module 50 may be located outside the substrate 40. An adhesive is provided between the lower surface 53 of the lens module 50 and the first bottom portion 45 of the first cavity 44, and the lens module 50 is fixed to the cavity 43. The adhesive may be, for example, an ultraviolet curable adhesive. A portion (an attachment portion) of the optical fiber 11 located on the substrate 40 extends along the first surface 41 of the substrate 40. A central axis of the attachment portion is located inside the cavity 43. As a result, the end portion of the optical fiber 11 extends straight on the second end surface 40b of the substrate 40 without bending.

A depth D1 of the first cavity 44 is optimized according to, for example, the thickness of the lens module 50 and the like. Here, the depth D1 of the first cavity 44 is a distance from the first surface 41 to the first bottom portion 45 in the thickness direction (the direction Z) of the substrate 40. In the present embodiment, the depth D1 of the first cavity 44 is equal to or more than half the thickness of the substrate 40 (the distance from the first surface 41 to the second surface 42). For example, when the thickness of the substrate 40 is 10, the depth D1 of the first cavity 44 may be 6 to 8.

The depth D1 of the first cavity 44 may be equal to or more than half a thickness T of the lens module 50. Here, the thickness T of the lens module 50 is a distance from the upper surface 52 to the lower surface 53 in the direction Z. As the depth D1 of the first cavity 44 becomes deeper, a larger portion of the lens module 50 is housed in the cavity 43, and thus the optical module 30 becomes thinner. In the present embodiment, the upper surface 52 of the lens module 50 is located outside the cavity 43 (above the first surface 41 of the substrate 40), but the upper surface 52 may be located inside the cavity 43 (flush with the first surface 41 of the substrate 40 or below the first surface 41).

A depth D2 of the second cavity 47 is larger than the depth D1 of the first cavity 44. Here, the depth D2 of the second cavity 47 is a distance from the first surface 41 to the second bottom portion 48 in the thickness direction of the substrate 40. The depth D2 of the second cavity 47 is optimized according to, for example, the thickness of the lens module 50 and the like. For example, when the thickness T of the substrate 40 is 10, the depth D2 of the second cavity 47 may be 7 to 9.

As described above, in the optical module 30 and the optical connector cable 1 according to the present embodiment, the cavity 43 recessed in the thickness direction (the direction Z) of the substrate 40 is provided, and at least a part of the lens module 50 is housed inside the cavity 43. As a result, the thickness of the optical module 30 is reduced by the amount of the lens module 50 which is housed in the cavity 43, and thus the optical module 30 becomes thinner. Accordingly, the optical connector cable 1 including the optical module 30 also becomes thinner. In the optical module of the related art in which the cavity 43 is not provided in the substrate, the lens module is placed on a flat surface of the substrate. In this case, a gap between the height of the optical fiber which extends outside the substrate and the height of the end portion of the optical fiber which is installed on the substrate is large, and thus it is necessary to bend the optical fiber significantly (it is necessary to increase the curvature). On the other hand, in the optical module 30 according to the present embodiment, the lens module 50 is housed in the cavity 43 of the substrate 40, and thus the height of the optical fiber 11 which is installed on the substrate 40 becomes low, and the above gap becomes small. In the optical module of the related art, as described above, the installing position of the optical fiber on the substrate is high. Thus, in a case in which the optical fiber is gently curved to reduce the bending, the disposition space for the optical fiber in an axial direction becomes large. On the other hand, in the optical module 30 according to the present embodiment, the installing position of the optical fiber 11 on the substrate 40 is lower than that of the example of the related art, and thus it is possible to reduce the disposition space for the optical fiber 11 in the axial direction. Therefore, the size of the optical module 30 can be reduced.

In the above embodiment, the lens module 50 has the groove portion 51 (the holding part) which holds the end portion of the optical fiber 11. According to this aspect, the end portion of the optical fiber 11 is held by the groove portion 51, and thus it is possible to make the optical coupling between the optical element 60 and the optical fiber 11 more accurate. Since it is not necessary to prepare a component having the groove portion 51 as a component separate from the lens module 50, component management at the time of manufacturing the optical module 30 becomes easy.

In the above embodiment, the cavity 43 is provided with the through hole that corresponds to the lens 56 of the lens module 50 and extends from the bottom portion of the cavity 43 to the second surface 42. The optical element 60 is mounted on the second surface 42 of the substrate 40 such that at least a part of the optical element 60 overlaps the through hole 48a in the thickness direction of the substrate 40. Thus, the lens 56 of the lens module 50 and the optical element 60 mounted on the side of the second surface 42 of the substrate 40 can be optically coupled to each other via a simple configuration of the through hole 48a.

In the above embodiment, the through hole 48a has a tapered shape in which an inner diameter decreases from the bottom portion of the cavity 43 toward the second surface 42. According to this aspect, the size of the through hole 48a can be made smaller than that of the straight through hole having a constant inner diameter. Accordingly, the strength of the substrate 40 can be maintained even in a case in which the through hole 48a is provided. By making the shape of the through hole 48a a tapered shape in which an inner diameter decreases from the bottom portion of the cavity 43 toward the second surface 42, it is possible to prevent the path of the light that converges from the lens 56 toward the optical element 60 from being obstructed. By reducing the inner diameter of the through hole 48a on the second surface 42, it is possible to expand a region in which a wiring pattern can be disposed on the second surface 42.

In the above embodiment, the cavity 43 has the first cavity 44 located close to the first surface 41 and the second cavity 47 having the second bottom portion 48 closer to the second surface 42 than the first bottom portion 45 of the first cavity 44. The through hole 48a is provided in the second bottom portion 48 of the second cavity.

According to this aspect, only a portion of the second cavity 47 that mainly houses the lens 56, which tends to protrude from a bottom surface of the lens module 50, is deepened, and the other portion (the first cavity 44) is made shallower than that portion. Therefore, it is possible to make a region of the entire cavity 43 smaller. As a result, it is possible to maintain the strength of the substrate 40 even in a configuration in which the substrate 40 is provided with the cavity 43.

In the above embodiment, the depth of the cavity 43 from the first surface 41 to the bottom portion is equal to or more than half the thickness of the lens module 50 or half the thickness of the substrate 40. As the depth of the cavity 43 becomes deeper, a larger portion of the lens module 50 can be housed inside the cavity 43. According to the above aspect, the optical module 30 can become even thinner.

In the above embodiment, a plurality of cavities 43 are provided with the substrate 40, and the beam part 43a extending from the inside of the substrate 40 to the outside thereof is provided between the cavities 43. According to this aspect, a part of an outer edge of each cavity 43 is defined by the beam part 43a. The strength of the substrate 40 is improved by the beam part 43a being provided.

In the above embodiment, the cavity 43 has two or more holes (positioning holes 45a) or marks used to position the lens module 50 with respect to the cavity 43. According to this aspect, the lens module 50 can be easily housed at an appropriate position in the cavity 43, and then the efficiency of optical coupling between the lens 56 and the optical element 60 can be improved.

In the above embodiment, the focal point F of the lens 56 is located at the inside of the optical element 60. According to this aspect, the optical coupling efficiency between the lens 56 and the optical element 60 can be maintained even in a case in which a slight deviation occurs in a relative position between the lens 56 and the optical element 60.

In the above embodiment, the attachment portion of the optical fiber 11 located on the substrate 40 extends along the first surface 41, and the central axis of the attachment portion is located inside the cavity 43. According to this aspect, it is possible to make the gap between the height of a portion of the optical fiber 11 which extends outside the substrate 40 and the height of the attachment portion of the optical fiber 11 smaller. As a result, the bending of the optical fiber 11 can be further reduced, and thus damage to the optical fiber 11 due to bending stress is further suppressed.

In the above embodiment, the lens module 50 has the mirror 55 which converts the propagation direction of the light L such that the light L emitted from the optical fiber 11 is incident on the optical element 60 or the light emitted from the optical element 60 is incident on the optical fiber 11. According to this aspect, the optical fiber 11 located along the substrate 40 and the optical element 60 located with respect to the optical fiber 11 with the substrate 40 interposed therebetween can be optically coupled to each other using the mirror 55.

Although the embodiment of the present disclosure is described in detail above, the present disclosure is not limited to the above embodiment and can be applied to various embodiments. For example, the cavity 43 may not have the second cavity 47 and may be formed to have a uniform depth. At this time, the bottom portion of the cavity 43 may be a placement surface that is flat as a whole, and the lens module 50 may be placed on the placement surface. The first bottom portion 45 of the first cavity 44 may have a plurality of projections, and the lens module 50 may be placed on the plurality of projections.

The optical module 30 in the above embodiment has a configuration in which the light L emitted from the optical fiber 11 is incident on the optical element 60, but may have a configuration in which light emitted from the optical element 60 is incident on the optical fiber 11. At this time, the optical element 60 may be a light emitting element such as a vertical cavity surface emitting laser (VCSEL). The light emitted from the optical element 60 may be converted into collimated light (parallel light) by the lens 56, reflected by the mirror 55, and then incident on the optical fiber 11.

What is claimed is:

1. An optical module comprising:
a substrate having a first surface and a second surface facing each other;
an optical element mounted on the substrate; and
a lens module having a lens configured to be optically coupled to the optical element, the lens module being configured to optically couple an optical fiber and the optical element to each other via the lens,
wherein the substrate is provided with a cavity recessed from the first surface toward the second surface to have a bottom portion, and
wherein at least a part of the lens module is housed inside the cavity.

2. The optical module according to claim 1, wherein the lens module has a holding part configured to hold an end portion of the optical fiber.

3. The optical module according to claim 1, wherein the cavity is provided with a through hole that corresponds to the lens of the lens module and extends from the bottom portion of the cavity to the second surface.

4. The optical module according to claim 3, wherein the optical element is mounted on the second surface of the substrate such that at least a part of the optical element overlaps the through hole in a thickness direction of the substrate.

5. The optical module according to claim 3, wherein the through hole has a tapered shape in which an inner diameter thereof decreases from the bottom portion of the cavity toward the second surface.

6. The optical module according to claim 3,
wherein the cavity has a first cavity located close to the first surface and a second cavity having a second bottom portion closer to the second surface than a first bottom portion of the first cavity, and
wherein the through hole is provided in the second bottom portion of the second cavity.

7. The optical module according to claim 1, wherein a depth of the cavity from the first surface to the bottom portion is equal to or more than half a thickness of the lens module or half a thickness of the substrate.

8. The optical module according to claim 1,
wherein the cavity includes a plurality of cavities, and
wherein a beam part extending from an inside of the substrate to an outside thereof is provided between the cavities.

9. The optical module according to claim 1, wherein the cavity has two or more holes or marks used to position the lens module with respect to the cavity.

10. The optical module according to claim 1 wherein a focal point of the lens is located at an inside of the optical element.

11. The optical module according to claim 1,
wherein an attachment portion of the optical fiber located on the substrate extends along the first surface, and
wherein a central axis of the attachment portion is located inside the cavity.

12. The optical module according to claim 1, wherein the lens module has a mirror that converts a propagation direction of light such that light emitted from the optical fiber is incident on the optical element or light emitted from the optical element is incident on the optical fiber.

13. An optical connector cable comprising:
the optical module according to claim 1; and
an optical fiber cable having at least one optical fiber,
wherein the optical fiber cable is attached to the optical module such that the optical fiber is optically coupled to the optical element via the lens.
